(19) United States
(12) Patent Application Publication
(10) Pub. No.: US 2006/0228488 A1
(43) Pub. Date: Oct. 12, 2006

(54) Method for preparing copper interconnectors of an ULSI

(75) Inventors: Yuh Sung, Jhongli City (TW); Ming-Der Ger, Dasi Township (TW); Yu-Hsien Chou, Sinshih Township (TW); Chi-Liang Cheng, Bade City (TW)

Correspondence Address: BACON & THOMAS, PLLC, 625 SLATERS LANE, FOURTH FLOOR, ALEXANDRIA, VA, 22314, US

(73) Assignee: Chung Cheng Institute of Technology, National Defense University, Daxi Town (TW)

(21) Appl. No.: 11/171,215

(22) Filed: Jul. 1, 2005

(30) Foreign Application Priority Data
Apr. 8, 2005 (TW) 094111263

(51) Int. Cl. B05D 1/18; B05D 5/12; B05D 3/02

(52) U.S. Cl. 427/437; 427/97.9; 427/443.1; 427/372.2

(57) ABSTRACT

A method for depositing a copper layer on a substrate is disclosed. The method is achieved by heating a plating solution located between a heating device and a target substrate. Through the process illustrated above, metal nano-particles come out from the plating solution and deposit on a substrate with high aspect ratio. Surfactant can be selectively added for obtaining ultra-thin continuous film, void-free copper connectors. Furthermore, a copper film would achieve a preferred (111) crystallization orientation.

### BACKGROUND OF THE INVENTION

1. Field of the Invention

The present invention relates to a method for preparing a copper layer on a substrate and, more particularly, to a method which is suitable for depositing a seedlayer or copper connectors, and providing a copper film with (111) crystallization orientation on a semiconductor.

2. Description of Related Art

In the existing semiconductor industry, the main method for preparing copper connectors is electroplating which has fast deposition, stability and produces a high purity deposited layer. However, before performing the electroplating, a continuous and conductive copper seedlayer must be provided, which makes the process more complex.

The commonly conductive copper seedlayer can be made by using chemical vapor deposition (CVD), physical vapor deposition (PVD), or electroless plating, but each has different disadvantages. The precursor of CVD usually has strong toxicity and low stability, also, its rate of deposition is slow, and the purity of the plating film is difficult to control. The main flaw of PVD is that the ability of step-coverage is poor; especially when the width of copper connectors is less than 90 nm or the aspect ratio of depth to width is greater than 5, the rate of step-coverage will become seriously insufficient, as a result, the seedlayer spreads unevenly and is unable to construct continuously conductive films, which will diminish the reliability of the feature. The quantity of the stabilizer of a conventional electroless plating is hard to control, which easily causes high concentration of stabilizer and results in abnormal deposition. Additionally, after the sensitizing and activating process, the deposited layer becomes more difficult to adhere, which results in problems such as deteriorating in conductivity of the deposited layer.

Furthermore, with the limitation of the width of the copper connectors as set forth above, electroplating will become obsolete. Therefore, a new technique for preparing copper connectors in the ULSI is in demand. A technique using just one single step to produce a seedlayer with thin thickness, high rate of step-coverage, and good substrate-adhesion will be an advantage for producing copper connectors in the ULSI, which will compact the process and also have high quality results.

### SUMMARY OF THE INVENTION

The present invention relates to a method for depositing a copper layer on a substrate using electroless plating, which comprises the following steps: (a) providing a substrate, a plating tank with heating and cooling devices, a copper plating bath which is placed inside the plating tank; (b) using the heating device to heat the plating bath; then using the cooling device to cool the heated bath; and (c) placing a substrate into the plating bath with a gap between the heating device and the substrate; wherein the gap is filled with the plating solution; the heating temperature of the heating device is T1, the heating solution in the designed clearance shows temperature gradient; the substrate can have sub-micro or nano-trench or deep-via pattern.

The present invention also comprises another method for depositing a copper layer on a substrate using electroless plating, following step (c), step (d) rinsing and then drying the substrate.

In the method of the present invention, the heating and cooling device can heat and cool only part of the plating bath, so the plating bath can become a solution with a temperature gradient. The plating solution in the gap is connected to the plating bath in the plating tank; in-between the designed clearance, the heating temperature of the heating device is T1, which has no temperature limitation; a good temperature range is between 70˜400° C., and the best temperature range is between 80˜250° C.; additionally, the temperature of the plating solution on the surface of the substrate is lower than the temperature of heating device. Thus, the plating solution between the surface of the substrate and the heating device shows a temperature gradient. Besides, the size of the gap is not limited either; a good range is between 2 μm˜3000 μm, and the best range is between 50 μm˜500 μm. Because the gap is related to the plating tank, the plating bath in the tank can instantly replenish the consumed the concentration of the metallic ion from the bulk bath into the designed clearance, which helps the reaction process.

Moreover, the electroless copper plating bath of the present invention can be any kind in the prior art; a good solution is the solution mainly containing copper sulfate and Ethylene Diaminetetraacetic Acid (EDTA), and the best solution is the solution which contains an inhibitor, such as a surfactant. In general, a surfactant can reduce surface tension, and also restrain the growth of the metal deposited layer; thus, a surfactant can be taken as a kind of inhibitor. A suitable surfactant for the present invention can be any kind in the prior art; beneficial kinds include polyol, such as glycerin, polyethylene glycols (PEG), butylene glycol; alkylammonium bromide, such as cetyl trimethyl ammonium bromide (CTAB) [symbol] octadecyl trimethyl ammonium bromide (OTAB) [symbol] tetradecyl trimethyl ammonium bromide (TTAB); hydrosulfate and sulfonate, such as octylsulfate sodium, sodium dodecyl sulfate (SDS), sodium dodecylbenzene sulfonate (SDBS), dodecylbenzene sulfonic acid (DBSA); perfluorate, such as lithium perfluorooctane sulfonate (LiFOS), sodium perfluorooctanoate (SPFO); and any combination of the above.

If previously mentioned surfactants are applied in a non-isothermal deposition system, an extra thin seedlayer or pinhole-less copper conductor can be made, wherein the category of alkylammonium bromides has the best results. Additionally, the concentration of the surfactant depends on the plating conditions, and a good range is between 10˜700 ppm.

Furthermore, a substrate, has 3D-structure patterns is suitable for preparing copper connectors of the present invention, and such patterns can be any pattern used in conventional methods. The beneficial kinds can be trenches and/or deep-vias of sub-micro type and/or nano type; for convenience, the substrate can be fixed on a terrace.

The method of the present invention is to produce a copper layer by using electroless plating, which is suitable for producing a seedlayer, copper connectors or a copper film with (111) crystallization orientation.

The present invention relates to a method of producing seedlayer and copper connectors, by using high temperature heating method, a part of the solution of the extremely small clearance between the substrate and the heater is heated directly. Through the electroless plating process, metal nano-particles are formed from the plating solution in-between the heating device and the cooling device by self-assembly nucleation and deposited on the substrate by diffusion, such as heat diffusion or mass transfer of nano-particles. The nano-particles are deposited in a 2D order and stacked in 3D structures directly on the trenches or deep-vias. Furthermore, the cooling device takes the extra heat energy away, so the non-reacted plating bath can stay stable and will not spontaneously decompose.

During the process illustrated above, depending on the amount of surfactants added, ultra-thin and continuous film and void-free copper connectors can be obtained. Furthermore, as the temperature increases, the copper crystallization in the plating bath of a non-isothermal system can enhance the (111) preferred crystallization orientation. Usually, convectional electroless plating will produce hydrogen during the chemical reaction, but non-isothermal bath is a high temperature system, so it can release the remained hydrogen in the deposited layer accompanying by the deposition of copper, some zero- and one-dimensional crystalline defects and vacancies can be partly eliminated by the non-isothermal system, additionally, the non-isothermal system assists the recrystallization of copper which makes coarsing grains and decreasing the grain boundaries. In the conventional method, the copper film has to go through high temperature annealing in order to obtain excellent (111) crystalline textures. In the method of the present invention, a seedlayer or a copper connector can directly undergo the heating treatment, by which the annealing step of the conventional method can be omitted.

The plating bath used in the method of present invention has high stability, and a non-conductive or non-catalytically-active substrate can immediately be used for chemical deposition without going through noble metal sensitizing and activating process first. Therefore, without the noble metal process, the deposited layer will not be difficult to adhere to the surface, and its conductivity will not deteriorate. Additionally, the cooling device can maintain a low temperature of the plating bath in the non-reaction area, which can prevent problems such as the Cannizzaro reaction or over consumption of formaldehyde. In the meantime, the distinguishing features of electroless plating are not affected, for example, the deposited layer is homogeneously covered and forms a geometric shape as the substrate. Furthermore, by using the non-isothermal heating system, the temperature of the solution in the designed clearance between the heating device and the substrate increases, and the addition of surfactants can decrease the surface tension of the solution; thus, the solution will enter and fill the nano or sub-micro inner structures easily.

### BRIEF DESCRIPTION OF THE DRAWINGS

FIG. 1 is a schematic drawing of the device of the present invention.

FIG. 2 is a partially enlarged schematic drawing of FIG. 1.

FIG. 3 is an image of the copper connectors produced in accordance with the method of the present invention.

FIG. 4 is an image of the seedlayer produced in accordance with the method of the present invention, wherein the thin deposited layer is the seedlayer (its shade is brighter), and the thickness of the layer is around 20 nm.

FIG. 5 is an image of the copper connectors produced in accordance with the method of the present invention.

FIG. 6 is an image of the copper connectors produced in accordance with the method of the present invention.

FIG. 7 is an image of the copper connectors produced in accordance with the method of the present invention.

FIG. 8 is an image of the copper connectors produced in accordance with the method of the present invention.

FIG. 9 is an image of the copper connectors produced in accordance with the method of the present invention.

FIG. 10 is an image of the copper connectors produced in accordance with the method of the present invention.

FIG. 11 is a relative diagram of the ratio between the (111) crystallization and (200) crystallization orientation under different temperatures.

### DETAILED DESCRIPTION OF THE PREFERRED EMBODIMENT

The main purpose of the present invention is to prepare seedlayers and copper connectors on a substrate 10 with patterns of trenches or deep-vias, and to investigate the influence of various deposition conditions on plating copper using electroless plating under the non-isothermal system. The main component of a plating bath 20 used in the present invention is copper sulphate, which can produce ultra thin and homogeneous seedlayers or non-pinhole copper layers. Furthermore, the present invention also selectively adds surfactants in the process, which can decrease the activity on the surface of the deposited layer, and control the thickness of seedlayer or overcome the defects of blocking which are caused by non-linear diffusion.

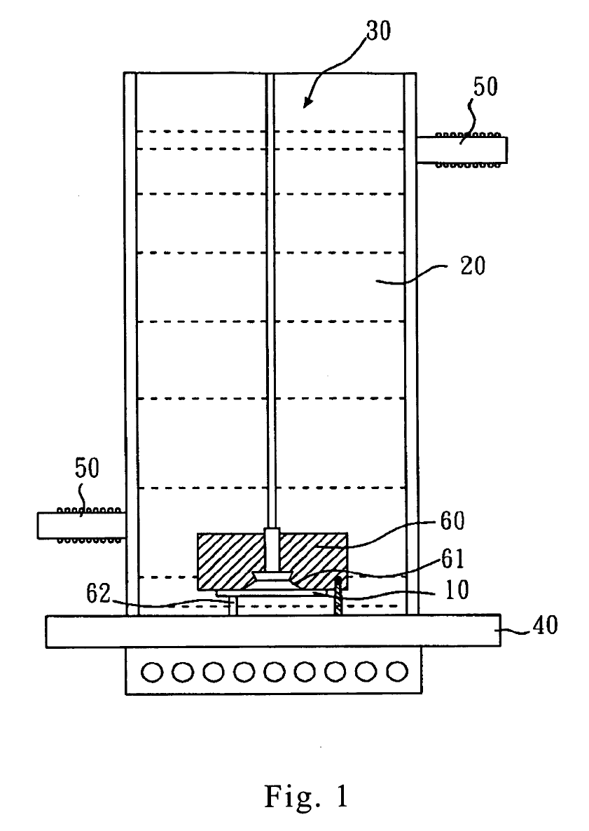

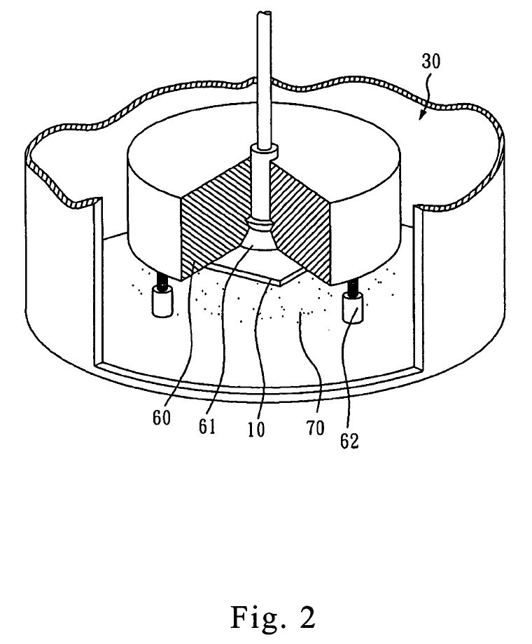

The method for producing seedlayers and copper connectors comprises steps as follows. FIG. 1 is a schematic drawing of the device for producing seedlayers and copper connectors, and FIG. 2 is the enlarged image of part of the FIG. 1. First, a substrate 10 with patterns of trenches or deep-vias is placed and cleaned in an organic solvent, which removes the oil sludge and impurities on the surface, so the lubricity on the surface of the substrate 10 can be increased, wherein, the size of the trenches or deep-vias can be of the order of nanometer or sub-micrometer. Second, the plating bath 20 is poured into a plating tank 30, and the heating device 40 and cooling device 50 are switched on at the same time, which will enable the solution 20 to have gradient temperature. The substrate 10 is placed and fixed on top of the base 60 which has a vacuum sucking disc 61. When the temperature of the solution reaches the targeted reaction temperature, the substrate 10 is placed in the plating tank to go through the chemical deposition of non-isothermal. The base 60 comprises at least one adjustable pillar 62, which enables a designed clearance to be formed between the substrate 10 and the heating device 40, and the size of the gap can be varied by adjusting the pillar 62. For example, the size of the gap can around 3 mm, but if the clearance is too big, the metal particles will easily diffuse from the inside of the gap to the outer solution. As a result, the amount of the deposited metal particles will be smaller as the distance of the gap increases. In another example, a suitable width of the gap is around 50˜500 μm, which enables the plating solution 20 in the gap to result in homogeneous self-assembly nucleation and metal nano-particles 70 (as shown in FIG. 2) are deposited on the surface of the substrate 10. Then, the nano-particles will form an ultra-thin and continuous metal film. The distinguishing feature of the present invention is using one single process to prepare seedlayers or copper connectors for an ULSI. The examples of the method for producing seedlayers, copper connectors, and copper film with preferred (111) orientation of copper crystallization are as follows:

### EXAMPLE 1

A non-conductive substrate with trenches (width of trenches is 12 μm and depth is 32 μm) on the surface is cleaned using acetone for 60 seconds at room temperature, and then is rinsed by de-ionized water for 20 seconds. Immediately, the cleaned substrate is placed into a plating tank containing a plating bath. The designed clearance between the substrate and the heating device is maintained at 150 μm; at this point, the temperature of the contact point between the plating solution and the heating device has reached 100° C., and the temperature of the plating bath in the plating tank becomes non-isothermal. After 10 minutes of deposition reaction, the substrate is removed from the plating tank, cleaned by the de-ionized water for 20 seconds at room temperature, and dried by nitrogen for 60 seconds; where after the process for forming the copper connectors is completed. As shown in FIG. 3, while the non-isothermal deposition is being performed, because of the non-linear diffusion problem, the seedlayers will have defects such as voids and pinholes. Such situation is similar to the results of using electroplating method, i.e., voids and pinholes in the deposited layer, which are caused by non-homogeneous electric current density. The composition of the plating bath is as follows:

| Composition of plating bath | Concentration |
|---|---|
| Copper sulphate | 0.03M |
| Formaldehyde | 0.33M |
| Ethylene diaminetetraacetic acid | 0.24M |
| (EDTA) | |
| Sodium hydroxide | Adjust pH of the solution to about 12.5 |

### EXAMPLE 2

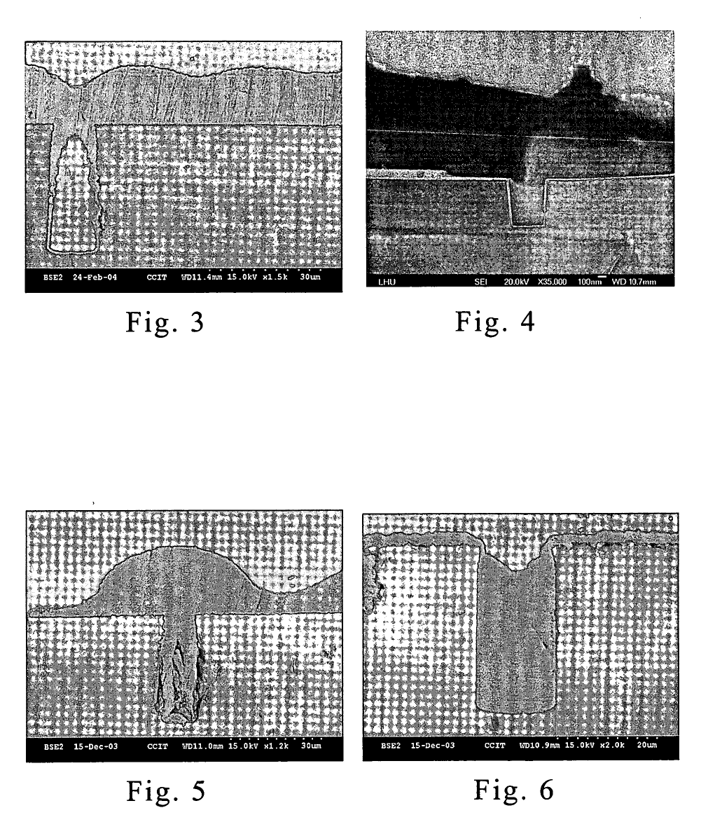

In this example, a non-conductive substrate with trenches (width of trenches is 0.25 μm and depth is 0.37 μm) on the surface is used to prepare seedlayers by using non-isothermal deposition, which is the same as the procedure in example 1. However, in this example, the plating bath has added thereto a 350 ppm of alkylammonium bromide, such as cetyl trimethyl ammonium bromide, while the other conditions remain the same. As shown in FIG. 4, the activity area of the surface of the seedlayer is covered by excessive cetyl trimethyl ammonium bromide, which reduces its activity and restrains the growth of interior and exterior microstructure of copper layers. As a result, ultra-thin and even seedlayer with thickness around 20 nm is produced. Additionally, based on the mentioned conditions, if the quantity of the surfactant is increased, the surfactant can effectively and quickly restrain the growth of the copper layer. As a result, a thinner seedlayer will be obtained. The composition of the plating bath is as follows:

| Composition of plating bath | Concentration |
|---|---|
| Copper sulphate | 0.03M |
| Formaldehyde | 0.33M |
| Ethylene diaminetetraacetic acid | 0.24M |
| (EDTA) | |
| Cetyl trimethyl ammonium | 350 ppm |
| bromide (CTAB) | |
| Sodium hydroxide | Adjust pH of the solution to about 12.5 |

### EXAMPLE 3

The procedure is similar to example 1, and a non-conductive substrate with trenches (width of trenches is 10 μm and depth is 30 μm) on the surface is used in this case. However, in this example, the plating bath has added thereto a 40 ppm of alkylammonium bromide, such as: cetyl trimethyl ammonium bromide, while the other conditions remain the same. As shown in FIG. 5, the problem of non-linear diffusion has obviously improved, and the defect inside the deposited layer has decreased. The composition of the plating bath is as follows:

| Composition of plating bath | Concentration |
|---|---|
| Copper sulphate | 0.03M |
| Formaldehyde | 0.33M |
| Ethylene diaminetetraacetic acid (EDTA) | 0.24M |
| Cetyl trimethyl ammonium bromide | 40 ppm |
| (CTAB) | |
| Sodium hydroxide | Adjust pH of the solution to |
| | about 12.5 |

### EXAMPLE 4

The procedure is similar to example 1, and a non-conductive substrate with trenches (width of trenches is 12 μm and depth is 32 μm) on the surface is used for producing a copper conductor. However, in this example, the plating bath has added thereto a 70 ppm of alkylammonium bromide, such as cetyl trimethyl ammonium bromide (CTAB), while the other variables remain the same. As shown in FIG. 6, the problem of non-linear diffusion has obviously been solved, and the defect inside the deposited layer is not found; such result indicates that the surfactant, according to the adsorption theorem, will adhere to the corner of microstructure to inhibit the reaction of deposition. As the trenches and microstructures of the vias get deeper, the surfactants will be influenced by the gradient density and the non-isothermal behavior, as depth increases, the quantity of surfactant contained gets lower, so the inhibition in the interior of trenches and deep-vias becomes unobvious. Therefore, the addition of the surfactant obviously restrains the non-linear diffusion. A peer test was performed on the deposited layer using tapes (3M CO. No. 250), and it was found that the adhesion of copper connectors and the substrate is very effective. Additionally, the surfactant can also restrain the growth of the deposited layer on the image surface, which will reduce the time of Chemical Mechanical Polishing (CMP), meaning the probability for the erosion of the copper connectors by the polisher of CMP is correspondingly reduced. The composition of the plating bath is as follows:

| Composition of plating bath | Concentration |
|---|---|
| Copper sulphate | 0.03M |
| Formaldehyde | 0.33M |
| Ethylene diaminetetraacetic acid (EDTA) | 0.24M |
| Cetyl trimethyl ammonium bromide | 70 ppm |
| (CTAB) | |
| Sodium hydroxide | Adjust pH of the solution to |
| | about 12.5 |

### EXAMPLE 5

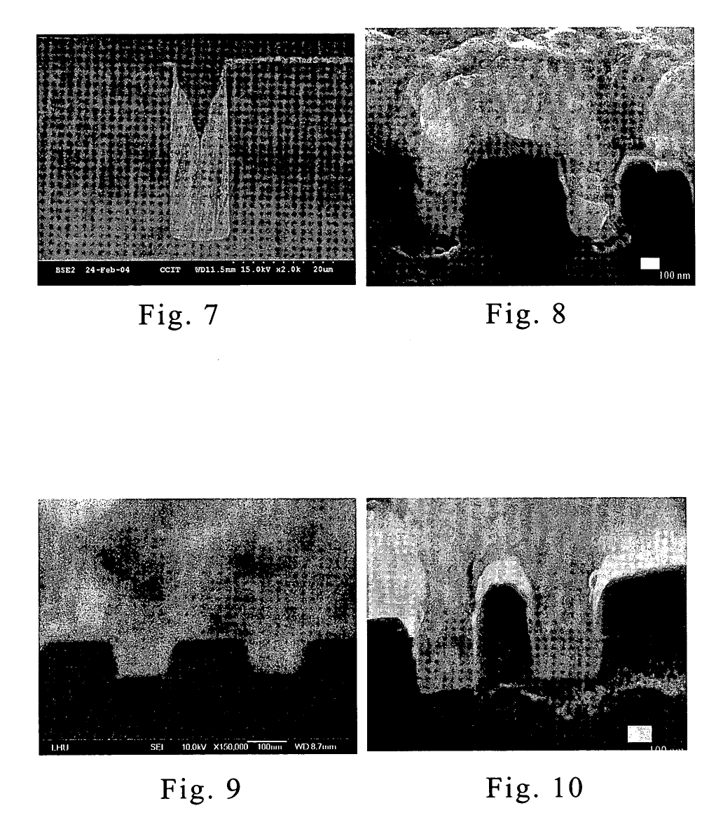

The procedure is similar to example 1, and a non-conductive substrate with trenches (width of trenches is 10 μm and depth is 30 μm) on the surface is used for producing copper conductor. However, in this example, the plating bath has added thereto a 130 ppm of alkylammonium bromide, such as cetyl trimethyl ammonium bromide (CTAB), while the other variables remain the same. As shown in FIG. 7, the problem of non-linear diffusion has been completely solved, and there is no defect shown inside the deposited layer. Furthermore, as the quantity of the surfactant increases, the image surface of deposited layer becomes thinner. Such result leads to a CMP procedure being no longer necessary. The composition of the plating bath is as follows:

| Composition of plating bath | Concentration |
|---|---|
| Copper sulphate | 0.03M |
| Formaldehyde | 0.33M |
| Ethylene diaminetetraacetic acid (EDTA) | 0.24M |
| Cetyl trimethyl ammonium bromide | 130 ppm |
| (CTAB) | |
| Sodium hydroxide | Adjust pH of the solution to |
| | about 12.5 |

### EXAMPLE 6

The procedure is similar to the example 1, and a non-conductive substrate with trenches (width of trenches is 0.25 μm and depth is 0.37 μm) on the surface is used for producing a copper conductor. However, in this example, the plating bath has added thereto another 100 ppm of alkylammonium bromide, such as: cetyl trimethyl ammonium bromide (CTAB), while the other variables remain the same. As shown in FIGS. 8˜10, void-free copper connectors can be obtained under these circumstances. A peer test on the deposited layer was performed using tapes (3M CO. No. 250), whereby the adhesion of both the conductive copper layer and the substrate is deemed to be very beneficial, and abruption does not happen. Furthermore, if the variables described above are applied to the production of 60 nm copper connectors, void-free and pinhole-free copper layers can be obtained. The composition of the plating bath is as follows:

| Composition of plating bath | Concentration |
|---|---|
| Copper sulphate | 0.03M |
| Formaldehyde | 0.33M |
| Ethylene diaminetetraacetic acid (EDTA) | 0.24M |
| Cetyl trimethyl ammonium bromide | 100 ppm |
| (CTAB) | |
| Sodium hydroxide | Adjust pH of the solution to |
| | about 12.5 |

As shown in the descriptions and results of examples 2 to 6, the plating bath with addition of the surfactant will stick at the comers of the openings of the substrates, which slows down the growth rate of the deposited layer and overcomes the infection of blockings that are caused by non-linear diffusion; as the quantity of the surfactant increases, the growth of interior and exterior microstructures of the deposited layer can be restrained. As a result, ultra-thin and even seedlayers can be obtained.

### EXAMPLE 7

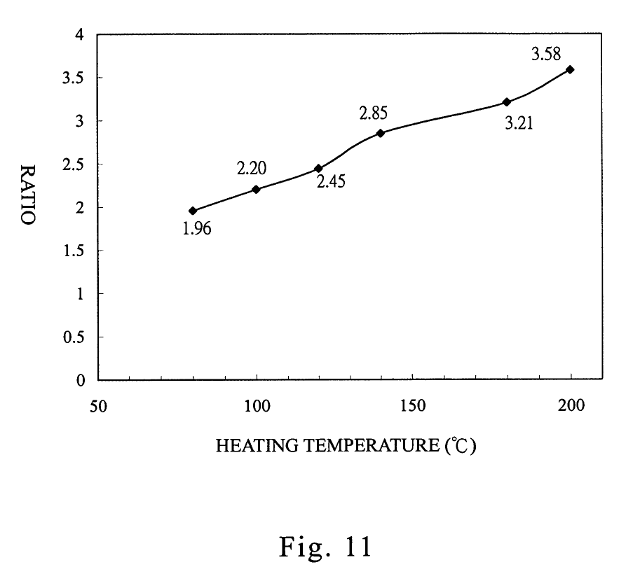

The purpose of this example is to show the changes of (111) crystallization orientation of the copper film under different heating temperatures, hydrogen will be released which remain in the deposited layer, crystalline defects and vacancies can be partly annihilated, grain boundaries degrease and grains become larger are all accompanied by elevating temperature. The procedure is similar to the example 1; however, besides the substrate, a silicon wafer with a flat surface is also used. As shown in FIG. 11, the increase of temperature is an advantage to the (111) crystallization orientation of the copper film in the non-isothermal system. As the heating temperature increases, the ratio between (111) crystallization and (200) crystallization orientation gets bigger. The result shows that the non-isothermal system has both depositing and annealing capabilities, by which the step of annealing in the conventional method can be omitted. The composition of the plating bath is as follows:

| Composition of plating bath | Concentration |
|---|---|
| Copper sulphate | 0.03M |
| Formaldehyde | 0.33M |
| Ethylene diaminetetraacetic acid | 0.24M |
| (EDTA) | |
| Heating temperature | 80˜200° C. |
| Sodium hydroxide | Adjust pH of the solution to about 12.5 |

In conclusion, by using the chemical deposition of non-isothermal system, the present invention relates to a method of producing copper connectors or seedlayers on an un-conductive substrate which has patterns of trenches and deep-vias. Unlike conventional methods, the method of the present invention can be done in one process, without the step of annealing.

Although the present invention has been explained in relation to its preferred embodiment, it is to be understood that many other possible modifications and variations can be made without departing from the spirit and scope of the invention as hereinafter claimed.

What is claimed is:

1. A method for depositing a copper layer on a substrate using electroless plating, which comprises steps as follows:
(a) providing a substrate, an plating bath, and a plating tank with a heating device and a cooling device, wherein said plating tank contains said plating bath;
(b) using said heating device to heat said plating bath; and using said cooling device to cool said heated plating bath; and
(c) placing said substrate into said plating bath, and leaving a gap between said heating device and said substrate; wherein said gap is filled with said plating solution; the temperature of said heating device is T1; and said substrate can have patterns of sub-micro or nano trenches or deep-vias.

2. The method as claimed in claim 1, wherein after step (c) there is step (d), rinsing and then drying the base.

3. The method as claimed in claim 1, wherein said temperature range of said T1 is between 70° C. and 400° C.

4. The method as claimed in claim 1, wherein the size of said gap is between 2 μm to 3000 μm.

5. The method as claimed in claim 1, wherein said plating bath contains a surfactant which can be taken as a kind of inhibitor, and such surfactant can be polyalcohol, alkylammonium bromide, hydrosulfate, sulfonate, perfluorate, or any combination of the above.

6. The method as claimed in claim 5, wherein said alkylammonium bromide can be cetyl trimethyl ammonium bromide (CTAB), octadecyl trimethyl ammonium bromide (OTAB), tetradecyl trimethyl ammonium bromide (TTAB), or any combination of the above.

7. The method as claimed in claim 6, wherein the quantity of said surfactant is between 10 to 750 ppm.

8. The method as claimed in claim 1, wherein said substrate is fixed on a base.

9. The method as claimed in claim 1, wherein said method is for producing copper connectors.

10. The method as claimed in claim 1, wherein said method is for depositing seedlayers.

11. The method as claimed in claim 1, wherein said method is for producing copper layers with (111) crystallization orientation.
